(19) United States
(12) Patent Application Publication
(10) Pub. No.: US 2026/0275033 A1
(43) Pub. Date: Sep. 17, 2026

(54) MACRO-CYCLIC POLYESTER OLIGOMERS PRODUCED DIRECTLY FROM DIOLS AND AROMATIC DICARBOXYLIC ACIDS, AND RELATED METHODS

(71) Applicant: JM Mihalich LLC, Falls Church, VA (US)

(72) Inventor: James Mihalich, Falls Church, VA (US)

(21) Appl. No.: 19/167,502

(22) PCT Filed: Mar. 15, 2024
(86) PCT No.: PCT/US2024/020111

§ 371 Date: Sep. 22, 2025

Related U.S. Application Data
(60) Provisional application No. 63/454,348, filed on Mar. 24, 2023.

(51) Int. Cl. C08G 63/19; B01J 31/02

(52) U.S. Cl. CPC C08G 63/19; B01J 31/0237; C08G 2115/00

(57) ABSTRACT

Known methods of production of macro-cyclic oligomers involve either (i) the depolymerization of a previously prepared polymer using a high dilution process to establish a thermodynamic equilibrium that favors cyclics over polymers, or (ii) using acid chlorides and diols in one or two solvent systems. As presented herein, it is found that by using a selected composition, a moisture tolerant catalyst, a suitable solvent, and a limited concentration profile, macro-cyclic oligomers can be produced directly in a one-step process, eliminating the need to first produce polymer or perform other additional process steps.

### CROSS REFERENCE TO RELATED APPLICATIONS

This application claims priority to and benefit of U.S. Provisional Patent Application No. 63/454,348, filed Mar. 24, 2023, the contents of which is incorporated by reference herein in its entirety.

### TECHNICAL FIELD

This invention relates generally to polymer processing technology at any scale-lab, pilot plant, and industrial. In certain embodiments, the invention relates to the production of macro-cyclic polyester oligomers directly (e.g., in a one step process) from the reaction of a diol and an aromatic dicarboxylic acid in solvent and in the presence of a catalyst.

### BACKGROUND

Known methods of production of macro-cyclic polyester oligomers (“cyclics” or “cyclic oligomers” or “macrocyclic polyester oligomers” or “MPOs”) involve either (i) the depolymerization of a previously prepared polymer using a high dilution process to establish a thermodynamic equilibrium that favors cyclics over polymers, or (ii) using acid chlorides and diols in one or two solvent systems.

The preparation of cyclic arylates is described, for example, in U.S. Pat. Nos. 4,757,132; 4,927,904; and 5,136,018. In each of these, cyclic arylates are produced by reacting various diacid chlorides in non-polar solvents with a salt of various bisphenols in an aqueous solution combined in the non-polar solvent in the presence of a phase transfer catalyst. Each of these describes a batch reaction where one or both of the reactants are fed slowly into a reservoir of solvent which can include a reactant and phase transfer catalyst. They use a combination of slow feed rate, solvent in the reactor, and two separate phases created by using both a polar and non-polar solvent to an increase of reactant concentrations thus driving intermolecular reactants in favor of intramolecular reactants.

U.S. Pat. No. 4,829,144 describes a method to dissolve the diacid in a non-polar solvent and preparing a solution of a bisphenol salt in water. These are added to a vessel containing the non-polar solvent and an amine catalyst. An example involves creating the bisphenol salt in-situ with the diacid solution subsequently fed to the reactor which contained an existing solvent reservoir.

U.S. Pat. No. 4,927,904 describes the improvement in yield obtained by controlling the concentration and addition rates to create equal molar rate addition into a reactor containing existing solvent. This process uses the same reactants as in U.S. Pat. No. 4,829,144.

U.S. Pat. No. 5,136,018 discloses improved products by using two diacids to create a lower melt product. In all three cases described therein, pseudo high dilution was identified as an improvement over straight high dilution.

Processes to produce cyclic oligomers of alkene diols using diacids have also been described. For example, U.S. Pat. No. 5,039,783 describes an anhydrous process using a non-polar solvent as the diacid solvent and the solvent in the reactor along with an amine catalyst, and a polar solvent as the solvent for the diol. It also describes adding the catalyst and diacid separately. The catalyst can be added ahead of the reactants to the reactor, separately, or in conjunction with the diol.

U.S. Pat. No. 5,231,161 discloses a reason for the use of both a polar and non-polar solvent as the need to solubilize the diol. The process described in this patent eliminates the need for the polar solvent by reacting the diol in a separate step to make a bis-ester oligomer, which is then dissolved in the same non-polar solvent as the diacid. The patent also describes the use of two different amines as catalysts. The first is the unhindered tertiary amine described in U.S. Pat. No. 5,039,783. The second is the substitution of most of this amine with tri-alkylamine where the alkyl groups contain 1-6 carbon atoms, with triethylamine being preferred.

Both U.S. Pat. Nos. 5,039,783 and 5,231,161 describe pseudo-high dilution as an improvement over high dilution to favor inter-molecular reactions over intra-molecular reactions, which would lead to the formation of high molecular weight polymer.

There is also a method to produce cyclics by establishing a highly dilute solution where a preponderance of cyclics exist. A description of this approach is summarized in U.S. Pat. No. 8,283,437. Many of the described approaches are for polybutylene terephthalate and use polymer as a feedstock. This provides stoichiometry control and reduces the need to remove end groups such as water or methanol if reactions are done from monomers. This approach will produce cyclic arylates; however, the resulting product has a melt temperature over 300° C. which severely limits the products commercial utility.

U.S. Pat. No. 4,740,583 discloses cyclic polycarbonate and the composites made from them. The described process to make cyclics uses a two phase system, water and an organic solid. No method of forming composites, beyond using a transesterification catalyst, is described.

U.S. Pat. No. 6,627,830 discloses resorcinol containing polyarylate composites of certain compositions and properties. An upper limit of 60 weight percent fiber is described because of the difficulty of incorporating fibers or other fillers into a high molecular weight, amorphous polymer.

In-situ-polymerized thermoplastic composites have been introduced commercially for polybutylene terephthalate, nylon 6, and polyacrylates. These have glass transition points below 110° C. Few polymers have glass transition points above 140° C. and all of them have high melt viscosities. This makes incorporation of continuous or long fibers difficult.

### SUMMARY

Presented herein are macro-cyclic oligomer compositions and methods of their preparation. In certain embodiments, it is found that by using a selected composition, a moisture tolerant catalyst, a suitable solvent, and a limited concentration profile, macro-cyclic oligomers can be produced directly in a one step process, eliminating to need to first produce polymer or perform other additional process steps.

Most prior methods of producing cyclic oligomers were designed to make oligomers which can be ring opened and polymerized to form commercial polyesters. Current commercial polymers are produced from a variety of diols but principally with terephthalic acid (TPA). The predominate use of TPA confers improved thermal and mechanical properties over polymers based on isophthalic acid (IPA). This selection for improved properties places a burden on the production of cyclic oligomers directly from monomers because TPA is less soluble than IPA in commercially preferred solvents.

As described herein, in certain embodiments, by using IPA as the primary basis for the oligomer and subsequent polymer, it is found that one can achieve a lower cost and simpler process for cyclic production. The cyclic oligomers produced thereby can be used, for example, in thermoplastic composites. Using this approach for cyclic production, one may look to the diol selection to extend final polymer properties.

In certain embodiments, one feature of the methods described herein is the ability to make cyclic oligomers using aromatic dicarboxylic acid having at least 60% isophthalic acid with the remainder terephthalic acid. In certain embodiments, the diol used can be ethylene glycol, butanediol, cyclohexanedimethanol, bisphenol A, resorcinol or hydroquinone, either separately or in combination.

In certain embodiments, another feature of the methods described herein is the use of a solvent where each of the reactants is in solution at a concentration from 0.02 to 0.3 molar. It is preferred for the cyclic to precipitate out of solution at a temperature below the reaction temperature when possible. In certain embodiments, useful solvents can include dichloromethane, tetrahydrofuran, toluene, xylene and chlorobenzene. In some embodiments, neat diol is fed as a fluid, with no additional solvent used.

In certain embodiments, another feature of the methods described herein is the use of a moisture tolerant catalyst. Because water is generated as a by-product of the esterification, the use of a moisture tolerant catalyst is a preferred element of the method. These can be organic bases such as triethylamine, N,N-diisopropylethylamine (DIPEA), N-methyl morpholine, diisopropylamine, 1,8-diazabicyclo(5.4.0) undec-7-ene (DBU), 4-dimethylaminopyridine (DMAP), pyridinium p-toluenesulfonate (PPTS), triazabicyclodecene (TBD), imidazole, and/or a quaternary ammonium salt (e.g., hexadecyltrimethylammonium bromide), for example. A moisture tolerant catalyst is a catalyst which maintains utility in the presence of a small but non-negligible amount of water, for example, an amount from about 0.02 to 0.6 molar concentration. For example, in some embodiments, a moisture tolerant catalyst, as the term is used herein, is a catalyst that maintains its utility in the presence of a non-negligible amount of water up to 0.02 molar concentration of water. In other embodiments, a moisture tolerant catalyst is a catalyst that maintains its utility in the presence of a non-negligible amount of water up to 0.05 molar of water, up to 0.1 molar of water, up to 0.2 molar of water, up to 0.3 molar of water, up to 0.4 molar of water, up to 0.5 molar of water, or up to 0.6 molar of water. The potential for moisture tolerance of TBD is described, for example, in Jeung Gon Kim et al., “Triazabicyclodecene: A versatile catalyst for polymer synthesis,” Journal of Polymer Science, Vol. 62, Issue 1, Jan. 1, 2024, pp. 42-91.

In certain embodiments, the methods described herein use a heterogeneous version of the catalyst. This enables a continuous process where a carefully prepared, stoichiometrically balanced solution of reactants is passed over a catalyst bed with sufficient residence time to allow complete conversion.

For example, one can contact (i) a solution of IPA (e.g., at a concentration of 0.1 molar) in a solvent (e.g., toluene and/or xylene) with (ii) a solution of bisphenol A (BPA) (e.g., at a concentration of 0.01 molar) and TBD catalyst (e.g., at a concentration of 0.01 molar), both (i) and (ii) fed together into a continuous reactor. Following completion of the reaction, the catalyst could be removed via an ion exchange resin, and the water by-product and solvent could be separated from each other and the product using a known distillation method.

Other product formulations, catalysts and solvents can be used, for example, where the reactants are soluble within the given range and the catalyst is moisture tolerant.

In one aspect, the invention is directed to a method for manufacturing a macro-cyclic polyester oligomer, the method comprising reacting an aromatic dicarboxylic acid with a diol in the presence of a catalyst to form the macrocyclic polyester oligomer, wherein the catalyst is a moisture tolerant catalyst.

In another aspect, the invention is directed to a method for manufacturing a polyester (e.g., a polyarylate), the method comprising reacting an aromatic dicarboxylic acid with a diol in the presence of a catalyst to form the polyester, wherein the catalyst is a moisture tolerant catalyst.

In certain embodiments, the catalyst comprises an organic base selected from the group consisting of triethylamine, N,N-diisopropylethylamine (DIPEA), N-methyl morpholine, diisopropylamine, 1,8-diazabicyclo(5.4.0) undec-7-ene (DBU), 4-dimethylaminopyridine (DMAP), pyridinium p-toluenesulfonate (PPTS), triazabicyclodecene (TBD), imidazole, and quaternary ammonium salt (e.g., hexadecyltrimethylammonium bromide).

In certain embodiments, the catalyst comprises triazabicyclodecene (TBD).

In certain embodiments, the catalyst is a heterogeneous catalyst (e.g., a solid, or deposited on a solid) and the method comprises passing a solution comprising the aromatic dicarboxylic acid and the diol over a catalyst bed (e.g., wherein the method is a continuous process).

In certain embodiments, the method comprises reacting the aromatic dicarboxylic acid with the diol in a solvent solution, said solvent selected from the group consisting of dichloromethane, tetrahydrofuran, toluene, xylene, and chlorobenzene.

In certain embodiments, the method comprises reacting the aromatic dicarboxylic acid with the diol in a solvent solution, said aromatic dicarboxylic acid at a concentration from 0.02 to 0.3 molar in the solution, and said diol at a concentration from 0.02 to 0.3 molar in the solution.

In certain embodiments, at least 60 wt. % of the aromatic dicarboxylic acid is isophthalic acid (IPA) (e.g., with the remainder, e.g., 40 wt. % or less, terephthalic acid (TPA)).

In certain embodiments, the aromatic dicarboxylic acid is (i) isophthalic acid (IPA) or (ii) terephthalic acid (TPA) or (iii) a combination of IPA and TPA.

In certain embodiments, the polyester is a polyarylate, and wherein the method further comprises producing a macro-cyclic polyester oligomer from the polyarylate by re-equilibrating the polyarylate (e.g., in solution, in the presence of the catalyst), thereby producing the macro-cyclic polyester oligomer.

In certain embodiments, the polyester is a polyarylate (e.g., a part made with the polyarylate, wherein the part may also include reinforcing fillers or fibers), and wherein the method further comprises producing a macro-cyclic polyester oligomer from the polyarylate by re-equilibrating the polyarylate (e.g., in solution, in the presence of the catalyst), thereby producing the macro-cyclic polyester oligomer (e.g., and thereby recycling the part made with the polyarylate).

In certain embodiments, the method further comprises producing a composite containing at least 60 wt. % reinforcing material using the macro-cyclic polyester oligomer or the polyester.

Elements and features of embodiments described with respect to one aspect of the invention may be applied with respect to another aspect of the invention.

### BRIEF DESCRIPTION OF THE DRAWING

The foregoing and other objects, aspects, features, and advantages of the present disclosure will become more apparent and better understood by referring to the following description taken in conjunction with the accompanying drawings, in which:

FIG. 1 is a schematic diagram of a method of producing a macro-cyclic polyester oligomer or a polyester from the reaction of a diol and an aromatic dicarboxylic acid in the presence of a catalyst, according to certain embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

It is contemplated that compositions, methods, and processes of the claimed invention encompass variations and adaptations developed using information from the embodiments described herein. Adaptation and/or modification of the compositions, methods, and processes described herein may be performed, as contemplated by this description.

Throughout the description, where compositions are described as having, including, or comprising specific components, or where processes and methods are described as having, including, or comprising specific steps, it is contemplated that, additionally, there are compositions of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim. The documents mentioned herein, for example, in the Background section, are incorporated herein by reference in their entirety. Where there is any discrepancy in the meaning of a particular term, the meaning provided in the text of the specification that is not incorporated by reference is controlling.

Headers are provided for the convenience of the reader—the presence and/or placement of a header is not intended to limit the scope of the subject matter described herein.

As used herein, “macrocyclic” or “macro-cyclic” is understood to mean a cyclic molecule having at least one ring within its molecular structure that contains 5 or more atoms covalently connected to form the ring.

As used herein, an “oligomer” is understood to mean a molecule that contains one or more identifiable structural repeat units of the same or different formula.

As used in this application, the terms “macro-cyclic polyester oligomers”, “cyclics”, “cyclic oligomers”, “macrocyclic polyester oligomers” and “MPOs” are used as equivalents. This term is understood to mean a macrocyclic oligomer containing structural repeat units having an ester functionality. A macrocyclic polyester oligomer typically refers to multiple molecules of one specific repeat unit formula. However, a macrocyclic polyester oligomer also may include multiple molecules of different or mixed formulae having varying numbers of the same or different structural repeat units. Thus, the terms “macrocyclic polyester oligomer” and “macrocyclic polyester oligomers” (plural form) may be used interchangeably. Also, the terms “macrocyclic polyester oligomer” and “macrocyclic oligoester” are used interchangeably herein. A macrocyclic polyester oligomer may be a co-polyester or multi-component polyester oligomer, i.e., an oligomer having two or more different structural repeat units having ester functionality within one cyclic molecule.

General information about macro-cyclic polyester oligomers is found in International (PCT) Patent Application Publication No. WO2016126757, entitled “Methods for preparation of macrocyclic polyester oligomer from linear polyester,” the text of which is incorporated herein by reference.

Macro-cyclic polyester oligomers that may be made or employed using the methods described herein include, but are not limited to, macrocyclic poly(alkylene dicarboxylate) oligomers having a structural repeat unit of the formula:

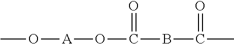

where A is an alkylene, or a cycloalkylene, or a mono- or polyoxyalkylene group; and B is a divalent aromatic or alicyclic group.

Macro-cyclic polyester oligomers include, without limitation, macrocyclic poly(1,4-butylene terephthalate) (cPBT), macrocyclic poly(1,3-propylene terephthalate) (cPPT), macrocyclic poly(1,4-cyclohexylenedimethylene terephthalate) (cPCT), macrocyclic poly(ethylene terephthalate) (cPET), macrocyclic polytrimethylene terephthalate PTT (cPTT), and macrocyclic poly(1,2-ethylene 2,6-naphthalenedicarboxylate) (cPEN) oligomers, and copolyester oligomers comprising two or more of the above repeating units.

Methods described herein may be used to produce macro-cyclic homo- and co-polyester oligomers. In one embodiment, macrocyclic ester homo- and co-oligomers produced via methods described herein include oligomers having a general structural repeat unit of the formula:

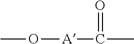

where A′ is an alkylene, cycloalkylene, or mono- or polyoxyalkylene group, and where A′ may be substituted, unsubstituted, branched, and/or linear. Example macro-cyclic polyester oligomers of this type include butyrolactone and caprolactone, where the degree of polymerization is one, and 2, 5-dioxo-1,4-dioxane, and lactide, where degree of polymerization is two. The degree of polymerization may also be 3, 4, 5, or higher. Molecular structures of 2,5-dioxo-1,4-dioxane and lactide, respectively, appear below:

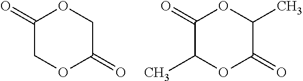

In general, a macro-cyclic polyester oligomer (an MPO) produced via methods described herein includes species of different degrees of polymerization, although, in certain embodiments, MPO with a high concentration of a particular species may be produced. Here, a degree of polymerization (DP) with respect to the MPO means the number of identifiable structural repeat units in the oligomeric backbone. The structural repeat units may have the same or different molecular structure. For example, an MPO may include dimer, trimer, tetramer, pentamer, and/or other species. In certain embodiments, the MPO is primarily (e.g., consists essentially of) dimer, trimer, tetramer, and/or pentamer species. In certain embodiments, the MPO is primarily (e.g., consists essentially of) trimer, tetramer, and/or pentamer species (e.g., C3+C4+C5).

As described herein, certain embodiments employ the use of an aromatic dicarboxylic acid. Examples of aromatic dicarboxylic acids include, for example, phthalic, isophthalic, and terephthalic acids, with ortho, meta, and para isomers thereof.

As described herein, terephthalic acid (TPA) is an organic compound with formula C₆H₄(CO₂H)₂ and chemical structure represented with either or both of the following:

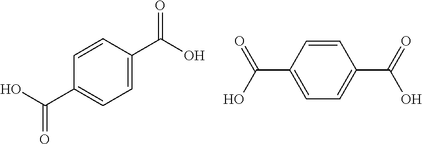 [SMILES: O=C(O)c1ccc(C(=O)O)cc1 ; O=C(O)c1ccc(C(=O)O)cc1]

As described herein, isophthalic acid (IPA) is an organic compound with formula C₆H₄(CO₂H)₂. IPA is an isomer of phthalic acid and terephthalic acid. IPA has chemical structure as follows:

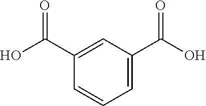 [SMILES: O=C(O)c1cccc(C(=O)O)c1]

Where methods described herein refer to the use of terephthalic acid (TPA), certain embodiments of those methods are also contemplated to include variations in which a dialkyl terephthalate such as dimethyl terephthalate (DMT) may be used instead of at least a portion of the TPA. For example, it is contemplated that a method described herein in which a reaction is performed using TPA and a diol includes embodiments/variations in which DMT is used instead of at least a portion of the TPA.

As used herein, “substantially free of” means that the composition contains no significant amount of the matter from which it is stated to be substantially free of (e.g., water and/or methanol). In some embodiments, a composition has less than about 20%, 10%, 5%, 2%, 1%, 0.5%, 0.1%, or 0.01% of matter from which it is stated to be substantially free of.

Various organic solvents may be used to practice the methods described herein. In some embodiments, the solvent includes at least one member selected from the group consisting of dichloromethane, tetrahydrofuran, toluene, xylene and chlorobenzene. In some embodiments, the organic solvent includes at least one member selected from the group consisting of tetradecane, hexadecane, octadecane, toluene, xylene, trimethylbenzene, tetramethylbenzene, ethylbenzene, propylbenzene, naphthalene, methylnaphthalene, biphenyl, triphenyl, diphyenyl ether (or a halogenated derivative thereof), anisol, methylene chloride, dimethyoxybenzene, chlorobenzene, dichlorobenzene, trichlorobenzene, chloronaphthalene, dichloronaphthalene, and/or a perfluorocarbon. In some embodiments of the methods and processes described herein, the organic solvent comprises a high-purity hydrocarbon solvent (e.g., Drakesol 165 (e.g., manufactured by Orica Chemicals), composed of acid treated light petroleum distillates). In some embodiments, the organic solvent comprises one or more components selected from the group consisting of oDCB (ortho-dichlorobenzene), toluene, o-xylene, pyridine, triethylamine, heptane, dibutyl ether, decane, and trichlorobenzene (TCB). In some embodiments, the organic solvent is or comprises xylene. In some embodiments, the organic solvent includes a perfluorocompound, such as perfluoro (tri-n-butylamine) and perfluoro (tri-n-pentylamine). The organic solvent used preferably has a boiling point no less than about 110° C. As used herein, the term “solvent” refers to solvents that are added to the reaction mixture, but does not include substances that may become part of a reaction mixture as a byproduct of a reaction described herein.

As described herein, preferred embodiments use a moisture-tolerant catalyst. Such a catalyst may include one or more organic bases such as triethylamine, N,N-diisopropylethylamine (DIPEA), N-methyl morpholine, diisopropylamine, 1,8-diazabicyclo(5.4.0) undec-7-ene (DBU), 4-dimethylaminopyridine (DMAP), pyridinium p-toluenesulfonate (PPTS), triazabicyclodecene (TBD), imidazole, and quaternary ammonium salt (e.g., hexadecyltrimethylammonium bromide), for example. A moisture tolerant catalyst is a catalyst which maintains utility in the presence of a small but non-negligible amount of water, for example, an amount from about 0.02 to 0.6 molar concentration. For example, in some embodiments, a moisture tolerant catalyst, as the term is used herein, is a catalyst that maintains its utility in the presence of a non-negligible amount of water up to 0.02 molar concentration of water. In other embodiments, a moisture tolerant catalyst is a catalyst that maintains its utility in the presence of a non-negligible amount of water up to 0.05 molar of water, up to 0.1 molar of water, up to 0.2 molar of water, up to 0.3 molar of water, up to 0.4 molar of water, up to 0.5 molar of water, or up to 0.6 molar of water. The potential for moisture tolerance of TBD is described, for example, in Jeung Gon Kim et al., “Triazabicyclodecene: A versatile catalyst for polymer synthesis,” Journal of Polymer Science, Vol. 62, Issue 1, Jan. 1, 2024, pp. 42-91. In certain embodiments, the methods use a heterogeneous version of the catalyst. This facilitates, for example, a continuous process in which a stoichiometrically balanced solution of reactants is passed over a catalyst bed with sufficient residence time to allow satisfactory (e.g., complete or near complete) conversion.

Other catalysts that may be used in the methods described herein (in addition to or in place of the moisture-tolerant catalyst described above) include, but are not limited to, organotitanate and/or organotin compounds, for example, a member selected from (or derived from) the group consisting of 2-ethylhexyl titanate, tetrakis-(2-ethylhexyl) titanate, tetrabutyl titanate, tetraisopropyl titanate, an alkoxy titanate, titanium methoxide, titanium ethoxide, diisopropoxide bis(2,4-pentanedionate), triethanolamine titanium in alcohol solvent, and butanediol titanate, or a heterogeneous derivative thereof.

In some embodiments, provided methods employ a solid comprising the catalyst (e.g., a support or substrate). In certain embodiments, a solid comprising the catalyst is (or comprises) a member selected from the group comprising catalyst-coated glass beads, catalyst-coated fiberglass, catalyst-coated silica gel, catalyst-coated melamine formaldehyde solids (e.g., solids, beads, etc.), and catalyst-adhered magnetic iron oxide. In some embodiments, a solid comprising a catalyst is or comprises catalyst-coated glass beads pretreated with diol. Without wishing to be bound by any particular theory, it is believed that pretreatment of the solid catalyst with diol may be advantageous because it replaces OH groups on the solid catalyst with OR groups (i.e., diol-derived ether groups), thereby avoiding the production of water. In some embodiments, a solid comprising a catalyst is catalyst-coated glass beads pretreated with 1,4-butanediol.

In certain embodiments, the methods described herein make use of glass beads coated with a catalyst, over which a reaction solution passes. In other embodiments, catalyst-coated silica gel may be used, or another catalyst-coated (or otherwise catalyst-containing) solid, e.g., in a packed bed or column, may be used.

In some embodiments of the methods and processes described herein, the reaction mixture comprises a diol. In certain embodiments, the diol is or comprises ethylene glycol, butanediol, cyclohexanedimethanol, bisphenol A, resorcinol, and/or hydroquinone. In certain embodiments, the diol includes but is not limited to: polyethylene glycol, polypropylene glycol, 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 1,5-hexanediol, 1,6-hexanediol, 1,8-octanediol, 1, 10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, and/or 1,4-cyclohexanediethanol. In some embodiments, the diol is polyethylene glycol. In some embodiments, the diol is butanediol. In some embodiments, the diol is 1,4-butanediol. In some embodiments of the methods and processes described herein, the reaction mixture comprises a phenol. In certain embodiments, the phenol is resorcinol. In other embodiments, the phenol is hydroquinone.

As described herein, the methods can be used to produce either cyclic oligomers or polymers via direct esterification. For example, polyarylates (PARs) can be produced. Polyarylates are a family of aromatic polyesters made from aromatic dicarboxylic acids and bisphenols.

It is contemplated that methods, systems, and processes described herein encompass scale-ups, variations, and adaptations developed using information from the embodiments described herein. For example, the methods described herein include pilot plant and plant-scale manufacturing processes whose feasibility is demonstrated by the laboratory-scale experiments described herein. The chemical reactions described herein may be performed using reactor equipment that is known to those of ordinary skill in the field of polymer manufacturing and processing, including, without limitation, for example, batch reactors, plug-flow reactors, continuously-stirred tank reactors, packed-bed reactors, slurry reactors, fluidized bed reactors, and columns. Chemical reactions described herein may be conducted in batch, semi-continuous, and/or continuous operation.

Scale-up of systems from laboratory to plant scale may be performed by those of ordinary skill in the field of polymer manufacturing and processing. For example, those of ordinary skill in this field may select reactor types, design experiments for obtaining kinetic data, develop and apply models for reactor design, develop economically optimum reactor design, and/or validate reactor designs via pilot plant and/or full scale reactor experiments. General information regarding reactors and the design of reactor systems for manufacture of products may be found, for example, in “Kinetics and Reaction Engineering,” John L. Falconer, editor, in The Engineering Handbook, Section X, Richard C. Dorf, editor-in-chief, CRC Press, Inc., ISBN 0-8493-8344-7, pp. 785-829 (1995).

Any suitable techniques for material separation, isolation, and purification may be adapted for application in manufacturing processes encompassed by various embodiments of the methods described herein, for example, techniques for distillation, extraction, reactive extraction, adsorption, absorption, stripping, crystallization, evaporation, sublimation, diffusional separation, adsorptive bubble separation, membrane separation, and/or fluid-particle separation. General information regarding separation processes and their design may be found, for example, in “Separation Processes,” Klaus Timmerhaus, editor, in The Engineering Handbook, Section VIII, Richard C. Dorf, editor-in-chief, CRC Press, Inc., ISBN 0-8493-8344-7, pp. 579-657 (1995).

It is also contemplated that methods, systems, and processes described herein may include pumps, heat exchangers, and gas-, liquid-, and/or solid-phase material handling equipment known to those of ordinary skill in the field of polymer manufacturing and processing.

Embodiments described herein may be performed as part of a continuous, semi-continuous, or batch process. Reactors may be single-stage or multi-stage. It is contemplated that methods of the invention may be combined or supplemented with reactors, systems, or processes that are known in the art.

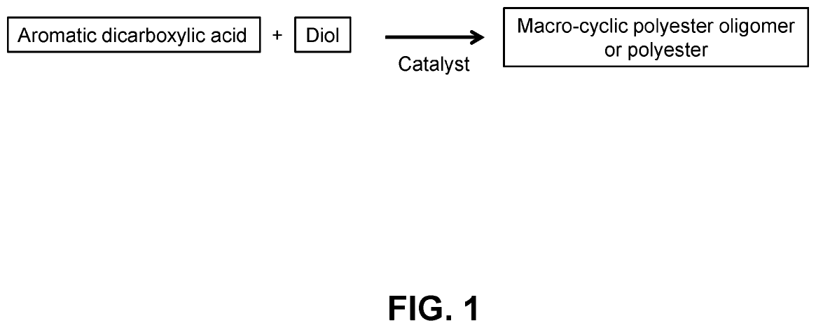

FIG. 1 is a schematic diagram of a method of producing a macro-cyclic polyester oligomer or a polyester from the reaction of a diol and an aromatic dicarboxylic acid in the presence of a catalyst, according to illustrative embodiments.

The certain embodiments, the catalyst comprises an organic base, for example, triethylamine, N,N-diisopropylethylamine (DIPEA), N-methyl morpholine, diisopropylamine, 1,8-diazabicyclo(5.4.0) undec-7-ene (DBU), 4-dimethylaminopyridine (DMAP), pyridinium p-toluenesulfonate (PPTS), triazabicyclodecene (TBD), imidazole, and/or quaternary ammonium salt (e.g., hexadecyltrimethylammonium bromide).

In certain embodiments, the catalyst comprises triazabicyclodecene (TBD). In certain embodiments, the catalyst is a heterogeneous catalyst (e.g., a solid, or deposited on a solid) and the method comprises passing a solution comprising the aromatic dicarboxylic acid and the diol over a catalyst bed (e.g., wherein the method is a continuous process).

In certain embodiments, the method comprises reacting the aromatic dicarboxylic acid with the diol in a solvent solution, said solvent selected from the group consisting of dichloromethane, tetrahydrofuran, toluene, xylene, and chlorobenzene.

In certain embodiments, the method comprises reacting the aromatic dicarboxylic acid with the diol in a solvent solution, said aromatic dicarboxylic acid at a concentration from 0.02 to 0.3 molar in the solution, and said diol at a concentration from 0.02 to 0.3 molar in the solution.

In certain embodiments, at least 60 wt. % of the aromatic dicarboxylic acid is isophthalic acid (IPA) (e.g., with the remainder, e.g., 40 wt. % or less, terephthalic acid (TPA)).

In certain embodiments, the aromatic dicarboxylic acid is (i) isophthalic acid (IPA) or (ii) terephthalic acid (TPA) or (iii) a combination of IPA and TPA.

In certain embodiments, the method further comprises producing a composite containing at least 60 wt. % reinforcing material using the macro-cyclic polyester oligomer or the polyester.

### EXPERIMENTAL EXAMPLES

The following are experimental examples illustrative of embodiments described herein.

### Example 1

A 250-milliliter round bottom flask was equipped with a stir bar, a Dean Stark Trap and reflux column, and a heating mantle. Into the flask 1.66 grams of isophthalic acid (IPA), 1.10 grams of resorcinol (RS), and 125 ml of toluene was placed. The flask was brought to reflux. While at reflux, particles of undissolved IPA were observed for over 5 minutes. Then, 0.14 grams of 1,5,7-triazabicyclo[4.4.0]dec-5-ene (TBD) were charged. Fifteen minutes after the TBD addition, the solution clarified and the solution was held for an additional hour, then allowed to cool and solids were filtered. The solids once dried were gummy and resinous. Running a Differential Scanning calorimetry test showed a broad shallow peak at about 239° C., consistent with the product being a low molecular weight linear oligomer. The published melting point of the RS-IPA polymer is 245° C.

High molecular weight polymer can be obtained by increasing the reaction concentration and/or employing known methods of improving yields, such as increasing time or temperature. This can either be used in a variety of commercial processes to produce parts or the polymer can be re-equilibrated to cyclic oligomer in a high dilution reactor with a suitable catalyst.

By performing the reaction at a higher dilution, cyclics can be produced directly.

The clarifying of the solution only following the addition of the TBD shows the reaction can advance independent of the solubility of the diacid in the solvent, and the catalyst's action on the diacid is sufficient to bring it into the reaction. This would enable either or both IPA and TPA to be incorporated into the reaction product.

It was surprisingly found that combined use of toluene, resorcinol, and TBD resulted in the reaction proceeding and mixture clarifying. Without wishing to be bound to any particular theory, it is believed the TBD acts on the IPA and brings it into solution where it reacts with the diol.

### Example 2

Example 1 was repeated but at one half the concentration: 0.837 grams of IPA, 0.552 grams of RS, 0.073 grams of TBD and 125 ml toluene. Fifteen minutes after reaching reflux it was noted that the reaction solution was clear with no suspended solids remaining. When removed from heat, a white free flowing powdery precipitate was immediately formed and filtered off while still hot. The filtrate was allowed to cool where additional free flowing powder precipitated. Both samples were allowed to dry with no additional heat, then weighed. The hot filtered sample yielded 0.926 grams, the dried hot filtrated was 0.450 grams. Assuming the hot filtered sample included any crystalized cyclic oligomer and unreacted IPA, and the filtrate included any unreacted RS, and TBD, this indicates 32% of the RS was consumed. DSC's were run on the hot filtered sample. The hot filtered sample showed distinct peaks at 310° C., 317° C., and 339° C. The published melting point of the RS-IPA polymer is 245° C. The demonstrated peaks indicate they are crystalized cyclic oligomers.

A version of the above was performed, except where TBD, IPA, and solvent were added and held for five minutes during which no clarifying was observed, then, upon addition of RS, clarification was observed. Without wishing to be bound to any particular theory, it is believed that this demonstrates the reaction advancing, rather than simply demonstrating solvating properties of either the TBD or RS with toluene.

### Example 3

Example 2 was repeated but with bisphenol A (BPA) used as the diol. 0.834 grams of IPA, 1.141 grams of BPA, and 0.074 TBD were charged along with 125 ml of toluene. Again, the mixture appeared clear with no suspended solids after 15 minutes. Upon removal from heat there was again a precipitated observed. This was filtered off while hot and both the hot filtered solid and filtrate were allowed to dry. The hot filtered product yielded 1.046 grams with 1.039 grams in the second sample. This corresponds to 15% of the diol converted. The DSC of the hot filtered sample showed peaks at 288° C., 336° C. and 343° C. The published melt point of the BPA-IPA polymer is 270° C. IPA has a melt point of 343° C.

### EQUIVALENTS

It is to be understood that while the disclosure has been described in conjunction with the detailed description thereof, the foregoing description is intended to illustrate and not limit the scope of the claims. Other aspects, advantages, and modifications are within the scope of the claims.

This written description uses examples to disclose the invention, including the best mode, and also to enable any person skilled in the art to practice the present embodiments, including making and using any devices or systems and performing any incorporated methods. The patentable scope of the present embodiments is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for manufacturing a macro-cyclic polyester oligomer, the method comprising reacting an aromatic dicarboxylic acid with a diol in the presence of a catalyst to form the macrocyclic polyester oligomer, wherein the catalyst is a moisture tolerant catalyst.

2. A method for manufacturing a polyester (e.g., a polyarylate), the method comprising reacting an aromatic dicarboxylic acid with a diol in the presence of a catalyst to form the polyester, wherein the catalyst is a moisture tolerant catalyst.

3. The method of claim 1 or 2, wherein the catalyst comprises an organic base selected from the group consisting of triethylamine, N,N-diisopropylethylamine (DIPEA), N-methyl morpholine, diisopropylamine, 1,8-diazabicyclo(5.4.0) undec-7-ene (DBU), 4-dimethylaminopyridine (DMAP), pyridinium p-toluenesulfonate (PPTS), triazabicyclodecene (TBD), imidazole, and quaternary ammonium salt (e.g., hexadecyltrimethylammonium bromide).

4. The method of claim 1 or 2, wherein the catalyst comprises triazabicyclodecene (TBD).

5. The method of any one of the preceding claims, wherein the catalyst is a heterogeneous catalyst (e.g., a solid, or deposited on a solid) and the method comprises passing a solution comprising the aromatic dicarboxylic acid and the diol over a catalyst bed (e.g., wherein the method is a continuous process).

6. The method of any one of the preceding claims, wherein the method comprises reacting the aromatic dicarboxylic acid with the diol in a solvent solution, said solvent selected from the group consisting of dichloromethane, tetrahydrofuran, toluene, xylene, and chlorobenzene.

7. The method of any one of the preceding claims, wherein the method comprises reacting the aromatic dicarboxylic acid with the diol in a solvent solution, said aromatic dicarboxylic acid at a concentration from 0.02 to 0.3 molar in the solution, and said diol at a concentration from 0.02 to 0.3 molar in the solution.

8. The method of any one of the preceding claims, wherein at least 60 wt. % of the aromatic dicarboxylic acid is isophthalic acid (IPA) (e.g., with the remainder, e.g., 40 wt. % or less, terephthalic acid (TPA)).

9. The method of any one of the preceding claims, wherein the aromatic dicarboxylic acid is (i) isophthalic acid (IPA) or (ii) terephthalic acid (TPA) or (iii) a combination of IPA and TPA.

10. The method of claim 2, wherein the polyester is a polyarylate, and wherein the method further comprises producing a macro-cyclic polyester oligomer from the polyarylate by re-equilibrating the polyarylate (e.g., in solution, in the presence of the catalyst), thereby producing the macro-cyclic polyester oligomer.

11. The method of claim 2, wherein the polyester is a polyarylate (e.g., a part made with the polyarylate, wherein the part may also include reinforcing fillers or fibers), and wherein the method further comprises producing a macro-cyclic polyester oligomer from the polyarylate by re-equilibrating the polyarylate (e.g., in solution, in the presence of the catalyst), thereby producing the macro-cyclic polyester oligomer (e.g., and thereby recycling the part made with the polyarylate).

12. The method of any one of the preceding claims, further comprising producing a composite containing at least 60 wt. % reinforcing material using the macro-cyclic polyester oligomer or the polyester.
